(19) United States
(12) Patent Application Publication
(10) Pub. No.: US 2025/0033011 A1
(43) Pub. Date: Jan. 30, 2025

(54) HYDROCARBON PYROLYSIS SUBSTRATES AND SYSTEMS

(71) Applicant: Honeywell International Inc., Charlotte, NC (US)

(72) Inventors: Mark Triezenberg, Westmont, IL (US); Amanda Childers, Arlington Heights, IL (US); Abigail Parsons, South Bend, IN (US); Charles Lo, Peoria, AZ (US)

(21) Appl. No.: 18/361,431

(22) Filed: Jul. 28, 2023

(51) Int. Cl. B01J 4/00; B01J 6/00

(52) U.S. Cl. CPC B01J 4/001; B01J 6/008

(57) ABSTRACT

A fibrous substrate for depositing carbon generated from pyrolysis of a hydrocarbon may include at least one roll defining a plurality of rolled deposition surfaces configured to receive carbon generated from the pyrolysis. The fibrous substrate may further include at least one spacer between and spacing at least one pair of opposed deposition surfaces of the plurality of rolled deposition surfaces. A system for generating hydrogen gas may include a pyrolysis reactor configured to generate the hydrogen gas from a hydrocarbon through pyrolysis. The system may further include the fibrous substrate. A method for forming the fibrous substrate may include positioning the at least one spacer on a surface of a fibrous mat, and rolling the fibrous mat into the at least one roll.

### STATEMENT REGARDING FEDERALLY SPONSORED RESEARCH OR DEVELOPMENT

This invention was made with Government support under Government Contract No. 80LARC17C0014 awarded by NASA. The Government has certain rights in the invention.

### TECHNICAL FIELD

The present disclosure relates to systems for hydrocarbon pyrolysis and hydrocarbon pyrolysis substrates.

### BACKGROUND

An environmental control system (ECS) of a structure, such as a building or vehicle, may remove carbon dioxide expelled by occupants of an environment, such as a room or cabin, to maintain comfort and safety. In some instances, the carbon dioxide may be absorbed from the environment by a liquid sorbent and desorbed from the liquid sorbent for discharge from the structure. However, for an atmosphere limited structure, such as a spacecraft or submarine, such discharge of carbon dioxide may waste oxygen from the carbon dioxide that may otherwise be recovered. To extract oxygen from the carbon dioxide, the ECS may react the carbon dioxide with hydrogen gas to form methane through a Sabatier reaction. The ECS may produce at least a portion of this hydrogen gas by pyrolyzing methane, which may generate solid carbon as a byproduct. Carbon generated from gas-phase reactions may form loose soot, which has a small size that may become airborne in a moving fluid or a reduced gravity environment. This soot may foul surfaces, decrease air quality, and short-circuit electrical equipment within and/or downstream of a pyrolysis reactor.

### SUMMARY

In general, the disclosure describes hydrocarbon pyrolysis substrates and systems. The hydrocarbon may include methane. The substrates may include a fibrous substrate including at least one roll and at least one spacer. The fibrous substrate is configured to receive and store carbon deposited in the course of pyrolysis. The at least one spacer may promote gas flow along the at least one roll, and reduce or prevent blockage of gas flow paths along the at least one roll. The fibrous substrate may be periodically replaced and disposed between different runs of pyrolysis.

In some examples, the disclosure describes a fibrous substrate for depositing carbon generated from pyrolysis of a hydrocarbon. The fibrous substrate may include at least one roll defining a plurality of rolled deposition surfaces configured to receive carbon generated from the pyrolysis. The fibrous substrate may further include at least one spacer between and spacing at least one pair of opposed deposition surfaces of the plurality of rolled deposition surfaces.

In some examples, the disclosure describes a system for generating hydrogen gas. The system may include a pyrolysis reactor configured to generate the hydrogen gas from a hydrocarbon through pyrolysis. The system may further include a fibrous substrate. The fibrous substrate may include at least one roll defining a plurality of rolled deposition surfaces configured to receive carbon generated from the pyrolysis. The fibrous substrate may further include at least one spacer between and spacing at least one pair of opposed deposition surfaces of the plurality of rolled deposition surfaces.

In some examples, the disclosure describes a technique for forming a fibrous substrate for depositing carbon generated from pyrolysis of a hydrocarbon. The technique may include positioning at least one spacer on a surface of a fibrous mat. The technique may further include rolling the fibrous mat into at least one roll defining a plurality of rolled deposition surfaces configured to receive carbon generated from the pyrolysis. The rolling causes the at least one spacer to be positioned between and spacing at least one pair of opposed deposition surfaces of the plurality of rolled deposition surfaces.

The details of one or more examples are set forth in the accompanying drawings and the description below. Other features, objects, and advantages will be apparent from the description and drawings, and from the claims.

### BRIEF DESCRIPTION OF THE FIGURES

The details of one or more examples are set forth in the accompanying drawings and the description below. Other features, objects, and advantages will be apparent from the description and drawings, and from the claims.

FIG. 1 is a partial cross-sectional view of a fibrous substrate including at least one roll for depositing carbon generated from pyrolysis of a hydrocarbon.

FIG. 2 is a perspective view of a disc spacer for a fibrous substrate.

FIG. 3 is a perspective view of an elongated cylindrical spacer for a fibrous substrate.

FIG. 4 is a perspective view of a square spacer for a fibrous substrate.

FIG. 5 is a perspective view of an elongated column spacer for a fibrous substrate.

FIG. 6 is a side view of a fibrous substrate including an elongated rib.

FIG. 7 is a cross-sectional view of a fibrous substrate including a plurality of concentric rolls.

FIG. 8 is a cross-sectional view of a fibrous substrate including at least one spiral roll.

FIG. 9 is a cross-sectional view of a fibrous substrate defining a plurality of grooves.

FIG. 10 is a cross-sectional view of a fibrous substrate defining a plurality of staggered grooves.

FIG. 11 is a flowchart representing a technique for forming a fibrous substrate including at least one roll for depositing carbon generated from pyrolysis of a hydrocarbon.

FIG. 12 is a block diagram of a system for generating hydrogen gas including a pyrolysis reactor and a fibrous substrate.

### DETAILED DESCRIPTION

In general, the disclosure describes hydrocarbon pyrolysis substrates and systems.

Pyrolysis of hydrocarbons, such as methane and ethane, produces hydrogen gas and carbon. Carbon that is produced in a gas phase may form as suspended soot, which may foul surfaces or passages downstream of the fibrous substrates. To reduce an amount of carbon formed as soot, fibrous substrates described herein may include a surface with high surface area on which the carbon may form through heterogeneous nucleation processes, such as chemical vapor deposition.

Hydrocarbon pyrolysis (or methane pyrolysis in particular) is a chemical reaction with a relatively complicated pathway. Densifying a carbon-carbon composite (for example, for forming aircraft brakes) or avoiding soot and other high molecular weight hydrocarbons may benefit from a substrate that facilitates relatively uniform gas flow and carbon deposition. Factors affecting flow and deposition may include total outside surface area, total internal surface area, pathways for the gas to travel so to not adversely affect design, residence time, ease of removal from the reactor, and gas travel time. The configuration of the fibrous substrates in the reactor may facilitate achieving the above factors. For example, for the purpose of human space environmental control and life support system methane pyrolysis reactors, an operational target may be to achieve a high total surface area without blocking an inlet-to-outlet pathway of the gas.

As carbon collects on the fibrous substrates and the solid volume of the fibrous substrates increase, gaps or flow paths along the fibrous substrates may be reduced. For example, while initially deposition of carbon on fibers of the fibrous substrate may increase a surface area on which the carbon may collect (e.g., by increasing a diameter of the fibers), eventually the collected carbon may reduce a porosity of the fibrous substrates and/or increase a closed porosity of the fibrous substrates (e.g., by blocking voids and creating pockets of inaccessible surface area), or reduce gaps between opposed surfaces of fibrous substrates. Without adequate surface area available for the carbon to deposit, soot may begin to form and the fibrous substrate may be swapped out with an unloaded fibrous substrate. Throughout a particular operation, the accumulation of these loaded fibrous substrates may represent a significant volume and mass, and clean-up of soot may represent a significant maintenance and operational cost.

Certain pyrolysis systems may employ complete filled reactors, which may result in high pressure drops and low maintenance intervals, or skewed discs, which have the benefit of allowing a bypass and avoiding pressure drops, but may still require the gas make a tortuous pathway to react and deposit.

According to some examples of the disclosure, fibrous substrates described herein may prevent or reduce blockage of gas flow paths, and may be relatively easy to manufacture from a continuous fibrous mat. Thus, fibrous substrates according to the present disclosure may exhibit relatively low soot formation, long operational life, and/or reduced weight.

In some examples, a carbon fiber substrate (for example, a cassette) is fabricated from non-woven carbon fiber felt wound in a spiral roll or including concentric cylinders, separated by spacers. The spacers may allow unimpeded gas flow axially through the substrate. The spacers may include small blocks that reduce contact between substrate layers and the spacer, or long ribs span an entire length of the substrate. In some examples, a space between ribs is reachable via grooves on the top and bottom of the substrate. Fibrous substrates according to the present disclosure may allow substantially unimpeded gas flow, with a maximum substrate surface area parallel to the flow, and without sever bends (for example, 90° bends) in a reacting zone of the pyrolysis reactor.

In some examples, the disclosure describes a fibrous substrate for depositing carbon generated from pyrolysis of a hydrocarbon. The fibrous substrate may include at least one roll defining a plurality of rolled deposition surfaces configured to receive carbon generated from the pyrolysis.

The fibrous substrate may further include at least one spacer between and spacing at least one pair of opposed deposition surfaces of the plurality of rolled deposition surfaces. The at least one spacer may promote retention of inter-surface spacing between opposed deposition surfaces, and reduce or avoid collapsing of the roll. Additionally, the inter-surface spacing retained by the spacer may define at least one path for continued flow or migration of carbon through or along the roll, and for deposition of carbon on the plurality of rolled deposition surfaces. Thus, the at least one spacer may reduce or prevent resistance to or blockage of flow through the roll of fibrous substrate.

In some examples, the disclosure describes a system for generating hydrogen gas. The system may include a pyrolysis reactor configured to generate the hydrogen gas from a hydrocarbon through pyrolysis. The system may further include a fibrous substrate. The fibrous substrate may include at least one roll defining a plurality of rolled deposition surfaces for carbon generated from the pyrolysis.

Forming the fibrous mat to include at least one roll may facilitate maneuvering, orienting, and introducing the fibrous substrate into a pyrolysis chamber of a pyrolysis reactor, and removing the fibrous substrate from the pyrolysis reactor compared to other forms of fibrous substrates, for example, discs or stacked mats. Further, the at least one roll may be oriented longitudinally along a major axis of the pyrolysis reactor, such that carbon to be received by the at least one roll may flow along numerous paths defined between opposed roll surfaces of the at least one roll along the major axis. The fibrous substrate may further include at least one spacer between at least one pair of opposed deposition surfaces of the plurality of rolled deposition surfaces.

In some examples, the disclosure describes a technique for forming a fibrous substrate for depositing carbon generated from pyrolysis of a hydrocarbon. The technique may include positioning at least one spacer on a surface of a fibrous mat, and rolling the fibrous mat into at least one roll defining a plurality of rolled deposition surfaces for carbon generated from the pyrolysis. The rolling causes the at least one spacer to be positioned between and spacing at least one pair of opposed deposition surfaces of the plurality of rolled deposition surfaces.

Forming the fibrous substrate to include at least one roll may facilitate fabrication of the fibrous substrate, and reduce complexity and cost of fabrication or assembly of the fibrous substrate, compared to providing fibrous substrate in other forms or shapes. For example, a fibrous matrix may be formed or deposited as, or cut into, an elongated fibrous mat, and the elongated fibrous mat may be rolled into one or more rolls to form the fibrous substrate. The rolled configuration may also facilitate introducing and retaining the at least one spacer between opposed surfaces of the at least one roll. For example, the fibrous mat may hold the at least one spacer in place as the mat is being rolled into at least one roll. Thus, additional steps or materials for orienting and holding the spacer may not be necessary.

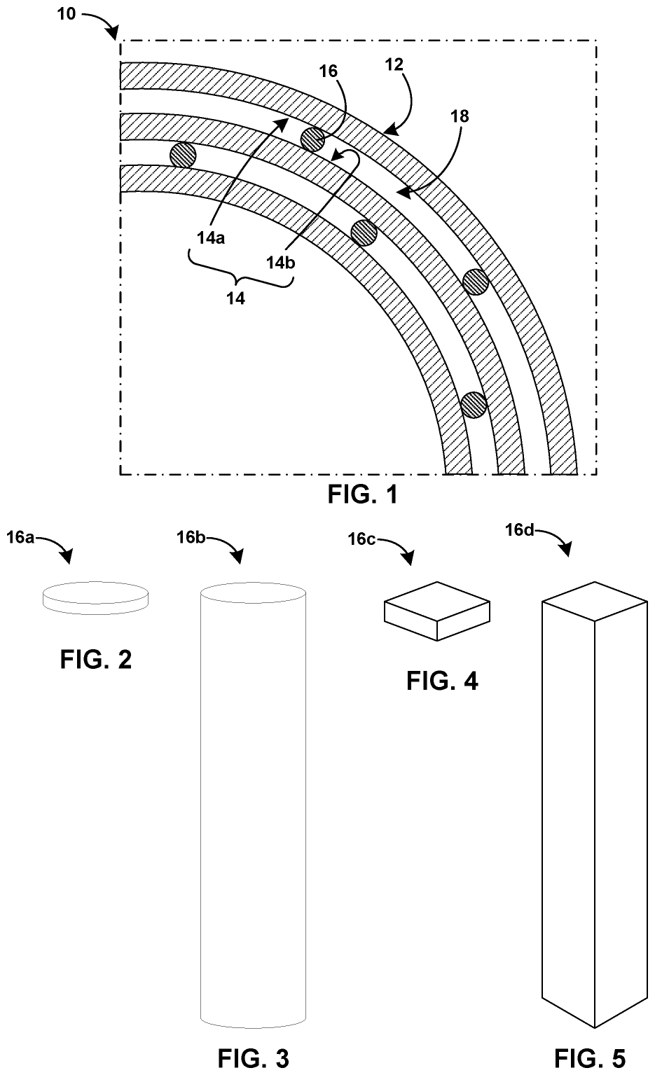

FIG. 1 is a partial cross-sectional view of a fibrous substrate 10 including at least one roll 12 for depositing carbon generated from pyrolysis of a hydrocarbon. For example, at least one roll 12 may include a fibrous mat, which may be rolled one or more times. Fibrous substrate 10 may be configured to be introduced into and retained in a pyrolysis reactor for receiving carbon formed by pyrolysis of the hydrocarbon in the pyrolysis reactor.

Fibrous substrate 10 may include no more than one roll 12, or may include two or more rolls 12. Two or more rolls may be interleaved, or stacked and rolled, and may each extend between ends of fibrous substrate 10, or may extend end-to-end along a longitudinal major axis of fibrous substrate 10.

At least one roll 12 may have a substantially constant thickness along an entirety of at least one roll 12, or may vary in thickness in one or more regions, or may continuously vary in thickness in a direction between opposing pairs of edges of at least one roll 12.

Fibrous substrate 10 may include at least one of carbon, ceramic, zirconia, silica, glass, metal or alloy, or combinations thereof. Fibrous substrate 10 may include fibers or aggregates of one or more such materials, for example, filaments, yarns, braids, mats, non-woven fabric, or woven fabric thereof. In some examples, fibrous substrate 10 includes, consists essentially of, or consists of carbon fiber.

Fibrous substrate 10 may include one or more binders to facilitate forming or retaining a shape of fibrous substrate or arrangement of fibers within the fibrous substrate. In some examples, fibrous substrate 10 does not include a binder.

At least one roll 12 defines a plurality of rolled deposition surfaces 14 configured to receive the carbon. Fibrous substrate 10 may further include at least one spacer 16 between and spacing at least one pair of opposed deposition surfaces 14a and 14b of the plurality of rolled deposition surfaces 14.

At least one spacer 16 may retain an inter-roll spacing 18 between opposed deposition surfaces 14a and 14b, for example, by reducing or avoiding contact between opposed deposition surfaces 14a and 14b. Further, at least one spacer 16 may retain a predetermined width of inter-roll spacing 18 along deposition surfaces 14, for example, a substantially uniform spacing between opposed deposition surfaces 14a and 14b. In some examples, at least one spacer 16 may retain a varying or tapering spacing between opposed deposition surfaces 14a and 14b in one or more sections. Inter-roll spacing 18 may have any suitable dimension. In some examples, inter-roll spacing is in a range from 2 mm to 5 mm.

As carbon is deposited onto or within opposed deposition surfaces 14a and 14b, fibrous substrate 10 may tend to exhibit a weight gain, or otherwise tend to deform from an initial configuration of at least one roll 12. At least one spacer 16 may promote the retention of the initial form or configuration of at least one roll 12. even when a substantial amount of carbon is received onto or within at least one roll 12.

At least one spacer 16 may include any suitable material that resists pyrolysis or otherwise retains form through pyrolysis. In some examples, at least one spacer 16 may include one or more of carbon in any suitable form (for example, graphitic carbon or carbon fiber), a ceramic, a metal or an alloy, or any suitable refractory composition. The at least one spacer 16 may include a compacted, densified, fibrous, or continuous matrix of material. In some examples, at least one spacer 16 is denser than a matrix of fibrous substrate 10.

At least one spacer 16 may have any suitable exterior three-dimensional shape, cross-sectional shape, or surface curvature or contour. For example, at least one spacer 16 may define a curved, polygonal, piecewise curved, piecewise polygonal, or any other cross-section or combinations thereof. In some examples, at least one spacer 16 defines a circular, elliptical, square, or rectangular cross-section, in a direction transverse to a major longitudinal axis along which at least one spacer extends. In some examples, at least one spacer 16 is spherical, oblong, ovoidal, or ellipsoidal. In some examples, at least one spacer 16 includes an elongated rod. At least one spacer 16 may have a substantially constant-cross sectional area along the longitudinal axis of at least one spacer 16, or may have a varying cross-sectional area. For example, the cross-sectional area may vary in one or both of shape or size.

At least one spacer 16 may include at least two, at least three, at least four, at least five, at least 10, at least 20, or more spacers. One or more spacers of at least one spacer 16 may differ from other spacers of at least one spacer 16 in one or more of three-dimensional shape, three-dimensional size, cross-sectional area, cross-sectional contour. Thus, at least one spacer 16 may include identical spacers or different types of spacers.

At least one spacer 16 may include multiple spacers arranged along inter-roll spacing 18 in any suitable pattern or spacing. For example, at least one spacer 16 may include uniformly spacers that are uniformly spaced along inter-roll spacing 18, or having a non-uniform spacing. Spacers in inter-roll spacing 18 and neighboring inter-roll spacings may be arranged in any suitable comparative patterns. For example, spacers in two neighboring inter-roll spacings may be positioned at staggered locations, or aligned locations along the inter-roll spacings. Spacers may differ in size, shape, form, or arrangement along a respective inter-roll spacing, between different inter-roll spacings, or at different heights along at least one roll 12.

In some examples, at least one spacer 16 is positioned about an exterior of at least one roll 12. For example, at least one spacer 16 may be positioned between an exterior of at least one roll 12 and an interior surface of a pyrolysis reactor. Such a configuration may provide a spacing between the interior surface of the pyrolysis reactor and at least one roll 12, which may promote gas flow along at least one roll.

Further examples of spacer geometry are described with reference to FIGS. 2-5.

FIG. 2 is a perspective view of a disc spacer 16a for a fibrous substrate. Disc spacer 16a may include one or more materials described with reference to spacer 16 of FIG. 1. Disc spacer 16a in FIG. 2 has a circular cross-section, but may have an elliptical, elongated, oblong, or oval cross-section in other examples. The thickness of disc spacer 16a is less than a major diameter of disc spacer 16a.

FIG. 3 is a perspective view of an elongated cylindrical spacer 16b for a fibrous substrate. Elongated cylindrical spacer 16b may include one or more materials described with reference to spacer 16 of FIG. 1. Elongated cylindrical spacer 16b may have a similar cross-section as described with reference to disc spacer 16a of FIG. 2. Elongated cylindrical spacer 16b may extend to any suitable length greater than a major diameter of spacer 16b. In some examples, elongated cylindrical spacer 16b extends longitudinally to ends of the fibrous substrate. In other examples, elongated cylindrical spacer 16b extends longitudinally along a portion or section of the fibrous substrate.

FIG. 4 is a perspective view of a square spacer 16c for a fibrous substrate. Square spacer 16c may include one or more materials described with reference to spacer 16 of FIG. 1. Square spacer 16c in FIG. 4 has a square cross-section. In other examples, spacer 16c may have a rectangular or polygonal cross-section. The thickness of spacer 16a is less than a major diameter of spacer 16c.

FIG. 5 is a perspective view of an elongated column spacer 16d for a fibrous substrate. Elongated column spacer 16d may have a similar cross-section as described with reference to spacer 16c of FIG. 4, for example, square, rectangular, or polygonal. Elongated column spacer 16d may extend to any suitable length greater than a major diameter of spacer 16d. In some examples, elongated column spacer 16d extends longitudinally to ends of the fibrous substrate. In other examples, elongated spacer 16d extends longitudinally along a portion or section of the fibrous substrate.

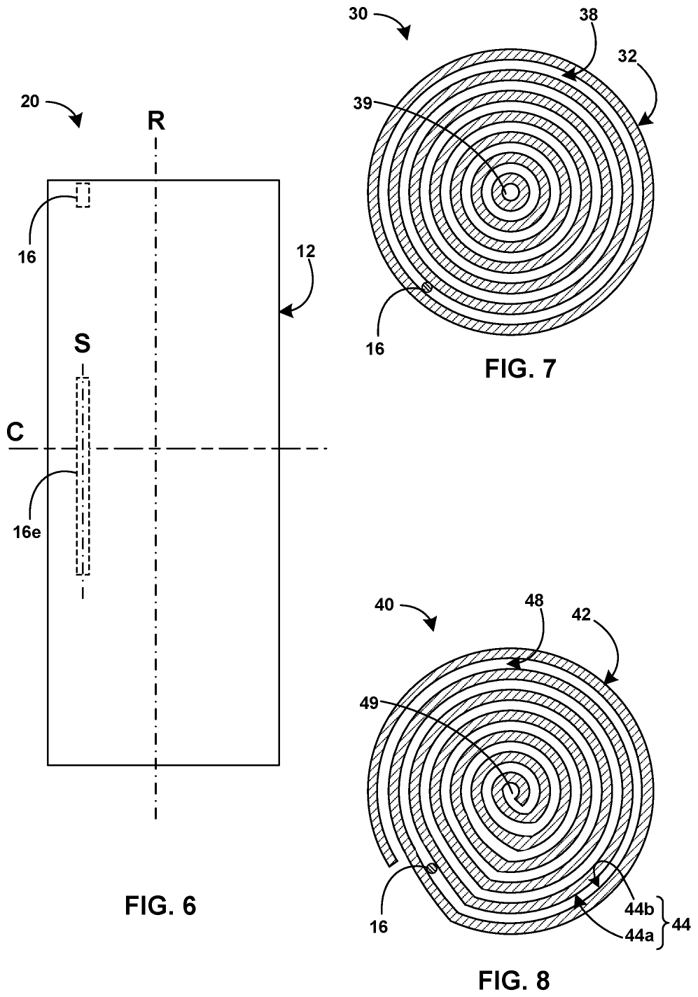

A fibrous substrate may include one or more spacers including an elongated rib, as described with reference to FIG. 6.

FIG. 6 is a side view of a fibrous substrate 20 including at least one elongated spacer 16e. Fibrous substrate 20 may be similar to fibrous substrate 10 described with reference to FIG. 1, or any other fibrous substrate according to the present disclosure. Fibrous substrate 20 may include at least one roll 12 extending in a direction along a roll axis R. At least one roll 12 is rolled about roll axis R.

At least one elongated spacer 16e may include one or more materials described with reference to spacer 16 of FIG. 1. At least one elongated spacer 16e may include an elongated spacer body, such as cylindrical spacer 16b described with reference to FIG. 3, elongated column spacer 16d described with reference to FIG. 5, or any other elongated spacer body having a longitudinal length greater than a major diameter. For example, the elongated spacer body may have a longitudinal length that is more than 100%, more than 200%, more than 300%, more than 400%, more than 500%, more than 600%, more than 700%, more than 800%, more than 900%, or more than 1000% of the major diameter.

At least one elongated spacer 16e extends in a direction parallel to roll axis R. For example, at least one elongated spacer 16e extends along longitudinal spacer axis S parallel to roll axis R. as shown in FIG. 6. At least one elongated spacer 16e may have any suitable length. For example, at least one elongated spacer 16e may be shorter than a length of at least one roll 12 along roll axis R. In some examples, at least one elongated spacer 16e extends along an entire length of the at least one roll 12.

Fibrous substrate 20 may include at least one spacer 16 described with reference to FIG. 1 (or any other spacer according to the present disclosure) in addition to at least one elongated spacer 16e, for example, any numeric combination of spacers 16 and 16e. One or more of spacers 16 and 16e may be located at different longitudinal or radial locations along at least one roll 12. For example, at least one elongated spacer 16e may extend across a central axis C of at least one roll 12.

Fibrous substrates according to the present disclosure may include concentric or spiral rolls, as described with reference to FIGS. 7 and 8.

FIG. 7 is a cross-sectional view of a fibrous substrate 30 including a plurality of concentric rolls 32. Fibrous substrate 30 may include one or more materials described with reference to fibrous substrate 10 of FIG. 1. Plurality of concentric rolls 32 may include two, three, four, five, six, seven, eight, nine, ten, or more rolls. Fibrous substrate 30 includes at least one spacer 16 (or any spacer according to the present disclosure), for example, between at least one opposed pair of rolls of plurality of concentric rolls 32. In some examples, each pair opposed pair of rolls of plurality of concentric rolls 32 includes at least one respective spacer of at least one spacer 16. At least one spacer 16 may include spacers that are aligned, staggered, uniformly spaced, non-uniformly spaced, or arranged in any suitable configuration described with reference to FIG. 1 along inter-roll spacing 38 between any opposed pair of rolls of concentric rolls 32 or with respect to neighboring inter-roll spacings between opposed pair of rolls.

Plurality of concentric rolls 32 may include rolls having substantially the same thickness, or may include at least one roll differing from at least one other roll in thickness. Inter-roll spacing 38 between each pair of opposed rolls of plurality of concentric rolls 32 may be substantially the same, or may be differ between at least two inter-roll spacings 38, for example, based on the number and arrangement of at least one spacer 16.

A center of concentric rolls 32 may be occupied by a column space 39, or may be occupied by solid fibrous material. Plurality of concentric rolls 32 may surround column space 39, a continuous column of fibrous material, or segments of fibrous material.

FIG. 8 is a cross-sectional view of a fibrous substrate 40 including at least one spiral roll 42. Fibrous substrate 40 may include one or more materials described with reference to fibrous substrate 10 of FIG. 1. At least one spiral roll 42 may include two, three, four, five, six, seven, eight, nine, ten, or more turns of a spiral. At least one spiral roll 42 may include two or more rolls, for example, radially interleaved rolls, or longitudinally stacked rolls.

Fibrous substrate 40 includes at least one spacer 16 (or any spacer according to the present disclosure), for example, between at least one pair of opposed deposition surfaces 44a and 44b of opposed deposition surfaces 44 between turns of at least one spiral roll 42. In some examples, each turn of at least one spiral roll 42 includes at least one respective spacer of at least one spacer 16. At least one spacer 16 may include spacers that are aligned, staggered, uniformly spaced, non-uniformly spaced, or arranged in any suitable configuration described with reference to FIG. 1 along inter-roll spacing 48 between any opposed deposition surfaces 44a and 44b along one or more turns of at least one spiral roll 42 or with respect to neighboring turns.

At least one spiral roll 42 may include turns having substantially the same thickness, or may include at least one turn differing from at least one other turn in thickness. In some examples, the thickness is substantially the same along an entirety of at least one spiral roll 42. In other examples, the thickness may vary continuously, smoothly, or in steps. Inter-roll spacing 48 between each pair of opposed turns may be substantially the same, or may be differ between at least two inter-roll spacings 48, for example, based on the number and arrangement of at least one spacer 16.

A center of at least one spiral roll 42 may be occupied by a column space 49, or may be occupied by solid fibrous material. At least one spiral roll 42 may surround column space 49, a continuous column of fibrous material, or segments of fibrous material.

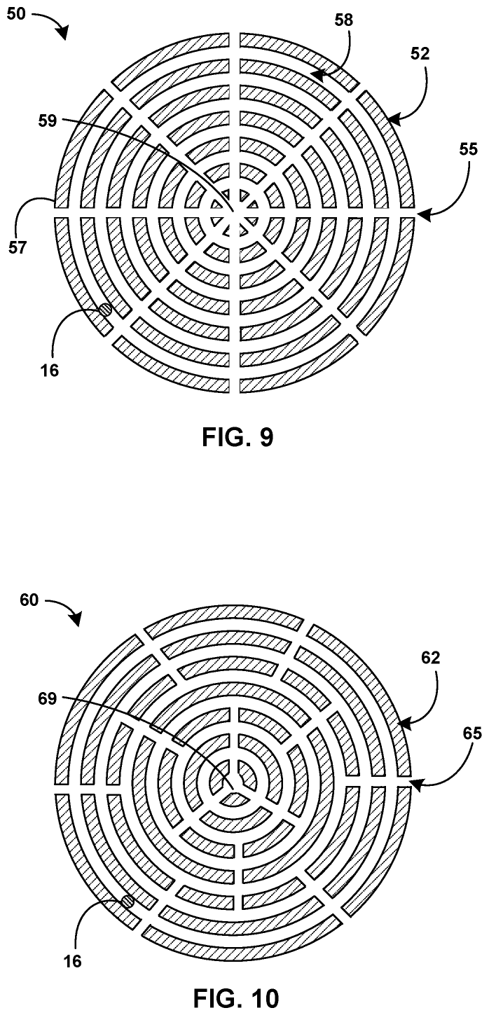

In some examples, fibrous substrates according to the present disclosure include at least one groove, for example, a groove transverse to a roll axis, as described with reference to FIGS. 9 and 10. The at least one groove may extend along one or both end surfaces of a fibrous substrate, or be adjacent to but spaced from the end surfaces of the fibrous substrate.

FIG. 9 is a cross-sectional view of a fibrous substrate 50 defining a plurality of grooves 55. Fibrous substrate 50 may include one or more materials described with reference to fibrous substrate 10 of FIG. 1. Fibrous substrate 50 may include at least one roll 52 similar to at least one roll 12 described with reference to FIG. 1, or plurality of concentric rolls 32 described with reference to FIG. 7, or at least one spiral roll 42 described with reference to FIG. 8. Fibrous substrate 40 includes at least one spacer 16 (or any spacer according to the present disclosure), for example, between at least one opposed pair of deposition surfaces.

Plurality of grooves 55 may facilitate entry of gas into at least one roll 52 and distribution of gas within at least one roll 52. In turn, such entry and distribution may promote uniform deposition of carbon along or into various portions or segments of at least one roll 52. Further, plurality of grooves 55 may provide alternative flow paths for gas or receiving carbon in case other paths are blocked. Plurality of grooves 55 may include two, three, four, five, six, seven, eight, nine, ten, or more grooves. Each groove of the plurality of grooves 55 extends along a respective direction transverse to a roll axis (for example, roll axis R described with reference to FIG. 6). The respective direction for one or more grooves may be inclined in any suitable angle relative to the roll axis. In some examples, the respective direction for at least one groove of plurality of grooves 55 is normal to the roll axis. In some such examples, the respective direction for each groove of plurality of grooves 55 is normal to the roll axis.

At least one groove of plurality of grooves 55 may extend through a

longitudinal center 59 of at least one roll 50. In some examples, each groove of plurality of grooves 55 extends through longitudinal center 59. Plurality of grooves 55 may be uniformly angularly positioned about longitudinal center 59, for example, subtending a substantially similar angle between each pair of neighboring grooves. In some examples, angles subtended by pairs of neighboring grooves of plurality of grooves 55 may differ in magnitude.

At least one roll 52 defines an outermost roll surface 57. In some examples, at least one groove of plurality of grooves 55 extends to outermost roll surface 57, for example, at one or both ends of the at least one groove. In some such examples, each groove of plurality of grooves 55 extends to outermost roll surface 57, for example, at one or both ends of the respective groove. In some such examples, each groove of plurality of grooves 55 extends to outermost roll surface 57 at one or both ends of the respective groove. In some examples, at least one groove of plurality of grooves 55 does not extend to outermost roll surface 57. In some examples, no groove of plurality of grooves 55 extends to outermost roll surface 57.

Plurality of grooves 55 may have substantially a same width in a radial direction transverse to the roll axis, or may differ in width. In some examples, each groove of plurality of grooves 55 has the same width. The width may be less than, equal to, or greater than an inter-roll spacing 58. In some examples, the width of each groove of plurality of grooves is the same as inter-roll spacing 58 between each roll of at least one roll 12.

Plurality of grooves 55 may have substantially a same depth in a longitudinal direction along the roll axis, or may differ in depth. In some examples, each groove of plurality of grooves 55 has the same depth. The groove depth of any groove of plurality of grooves may be less than, equal to, or greater than a groove width of the respective groove. In some examples, the depth of each groove of plurality of grooves is the same as a uniform width of grooves.

Plurality of grooves 55 may be positioned alone any plane, or along more than one plane, transverse to the roll axis of at least one roll 52. In some examples, plurality of grooves 55 are adjacent a first longitudinal end of at least one roll 52. In some examples, plurality of grooves 55 include two sub-pluralities of grooves present at both the first longitudinal end and a second longitudinal end of at least one roll 52. The two sub-pluralities of grooves may be identical, or differ in at least one aspect of groove geometry, position, or orientation. In some examples, at least some grooves of plurality of grooves 52 are arranged clockwise about the roll axis.

In some examples, plurality of grooves 55 extend within at least one roll 52 from a respective end surface of at least one roll 52. Such a configuration may facilitate entry of gas into at least one roll 52 even when an end surface of at least one roll is in contact with an inner surface of a pyrolysis reactor. Thus, plurality of grooves 55 may originate from an end surface of at least one roll 52, or may lie somewhat deeper than an end surface in a longitudinal direction along roll axis R.

FIG. 10 is a cross-sectional view of a fibrous substrate 60 defining a plurality of staggered grooves 65. Fibrous substrate 60 may include one or more materials described with reference to fibrous substrate 10 of FIG. 1. Fibrous substrate 60 may include at least one roll 62 similar to at least one roll 12 described with reference to FIG. 1, or plurality of concentric rolls 32 described with reference to FIG. 7, or at least one spiral roll 42 described with reference to FIG. 8. Fibrous substrate 60 includes at least one spacer 16 (or any spacer according to the present disclosure), for example, between at least one opposed pair of deposition surfaces.

Staggered grooves 65 may be similar to plurality of grooves 55 in geometric aspects such as width, depth, longitudinal location along the roll axis relative to an end surface of at least one roll 62. In some examples, plurality of grooves 55 includes staggered grooves 65 as a sub-plurality of grooves.

Staggered grooves 65 include at least one pair of grooves that do not completely extend between opposed roll surfaces of at least one roll 62, and extend along different concentric rolls or turns of rolls, or along different angular positions about a roll axis of at least one roll 62. Staggering the grooves may provide an alternative configuration of flow paths that may be further resistant to blockage, or may otherwise promote entry and distribution of gas along or within at least one roll 62, and ultimately, a uniform deposition of carbon along or within at least one roll 62. In some examples, at least some grooves of staggered grooves 62 are arranged clockwise about the roll axis.

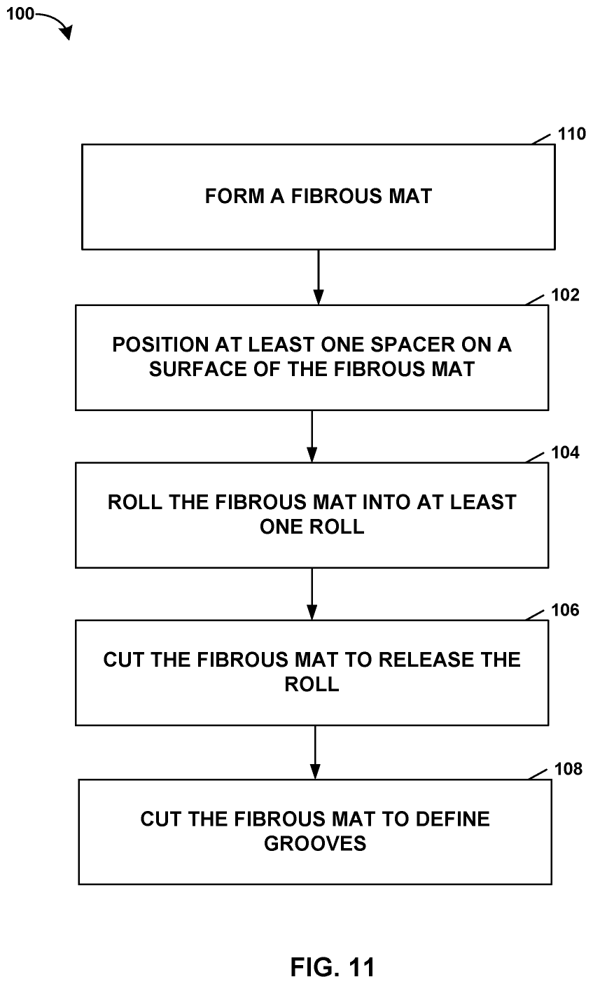

Techniques for forming a fibrous substrate are described with reference to FIG. 11. The techniques of FIG. 11 may be used to form any fibrous substrate according to the present disclosure. However, any suitable technique may be used to form fibrous substrates according to the present disclosure.

FIG. 11 is a flowchart representing a technique 100 for forming a fibrous substrate including at least one roll for depositing carbon generated from pyrolysis of a hydrocarbon. Technique 100 may include positioning at least one spacer on a surface of a fibrous mat (102). For example, the fibrous mat may be laid out on a surface or conveyor belt, and the at least one spacer may be placed or deposited on the fibrous mat. Technique 100 may further include rolling the fibrous mat into at least one roll defining a plurality of rolled deposition surfaces for the carbon (104). The rolling (104) may cause the at least one spacer to be positioned between and spacing at least one pair of opposed deposition surfaces of the plurality of rolled deposition surfaces. The rolling (104) may include rolling the fibrous mat about a spindle. In some examples, the rolling (104) may include extruding tubes of fibrous material of different radii, for example, for forming concentric rolls. The extruded tubes may be cut to form suitable lengths of tubes. In such examples, the rolling (104) may further include positioning tubes of different radii within each other to form concentric rolls. Alternatively, the rolling (104) may include rolling subsequent rolls of fibrous mats about interior rolls of fibrous mats.

The at least one roll may include a spiral roll or a plurality of concentric rolls. In some examples, the at least one roll longitudinally extends along a roll axis and the at least one roll defines a plurality of grooves. Each groove of the plurality of grooves may extend along a respective direction transverse to the roll axis.

After the rolling (104), technique 100 may further include cutting the fibrous mat (106). For example, the fibrous mat may be rolled in a continuous process, with intervening cutting to release or separate individual rolls. The cutting (106) may include cutting uniform length of the fibrous mat to be rolled into a spiral roll, or different lengths of the fibrous mat to be rolled into concentric rolls. For concentric rolls, ends of each concentric roll may joined together by a fastener or adhesive.

In some examples, technique 100 further includes cutting the fibrous mat to define grooves (108). In some examples, the grooves may be formed by a pattern of cuts introduced in the fibrous mat before the rolling (104). In some examples, the grooves are formed by a pattern of cuts after the rolling (104), for example, cutting a formed roll. The cutting (108) may include machining, stamping, die-cutting, or any other suitable technique for cutting the fibrous mat.

In some examples, technique 100 further includes, before positioning the at least one spacer (102), forming the at least one fibrous mat (110). Forming the fibrous may (110) may include depositing a fibrous material in a predetermined uniform or varying thickness. The fibrous material may include one or both of a carrier or a binder for holding together a matrix of the fibrous material.

The forming (110) may further include drying the fibrous material, for example, to substantially remove the carrier. The carrier may include an aqueous composition, for example, water, or a non-aqueous composition, for example, an organic solvent. The forming (110) may further include heat-treating the fibrous material, for example, to cure the binder, or to pyrolyze the binder.

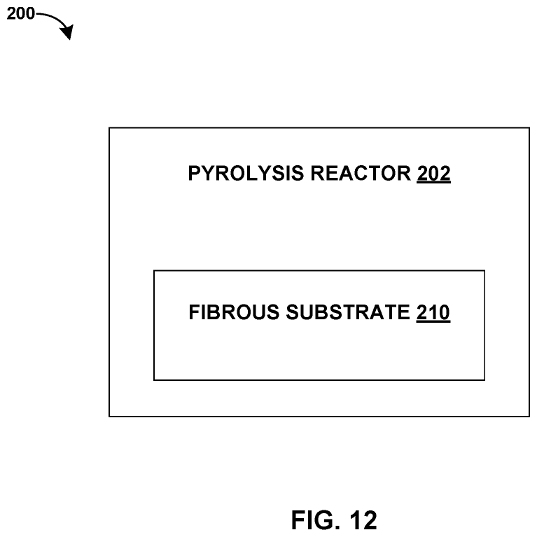

FIG. 12 is a block diagram of a system 200 for generating hydrogen gas including a pyrolysis reactor 202 and a fibrous substrate 210. Pyrolysis reactor 202 is configured to generate the hydrogen gas from a hydrocarbon through pyrolysis. For example, pyrolysis reactor 210 may include a hydrocarbon inlet, and a heating system configured to pyrolyze the hydrocarbon to generate the hydrogen gas and carbon.

Fibrous substrate 210 is introduced and retained in pyrolysis reactor 202, for example, before and during pyrolysis. Fibrous substrate 210 may include any fibrous substrate according to the present disclosure. For example, example, fibrous substrate 210 may include at least one roll defining a plurality of rolled deposition surfaces for the carbon. Fibrous substrate 210 may further include at least one spacer (for example, any spacer according to the present disclosure) between at least one pair of opposed deposition surfaces of the plurality of rolled deposition surfaces. The at least one roll may include a spiral roll or a plurality of concentric rolls. In some examples, the at least one roll longitudinally extends along a roll axis, and the at least one roll defines a plurality of grooves. Each groove of the plurality of grooves may extend along a respective direction transverse to the roll axis.

In some examples, pyrolysis reactor 202 extends along a longitudinal reactor axis, and the at least one roll longitudinally extends in a direction parallel to the longitudinal reactor axis. In some examples, pyrolysis reactor 202 includes an elongated reaction chamber, and fibrous substrate 210 is introduced into the elongated reaction chamber from an open end of the elongated reaction chamber. The elongated reaction chamber may be cylindrical, and fibrous substrate 210 may substantially conform to the elongated chamber.

The following clauses illustrate example subject matter described herein.

Clause 1: A fibrous substrate for depositing carbon generated from pyrolysis of a hydrocarbon, the fibrous substrate including: at least one roll defining a plurality of rolled deposition surfaces configured to receive carbon generated from the pyrolysis; and at least one spacer between and spacing at least one pair of opposed deposition surfaces of the plurality of rolled deposition surfaces.

Clause 2: The fibrous substrate of clause 2, where the at least one roll includes at least one spiral roll or a plurality of concentric rolls.

Clause 3: The fibrous substrate of any of clauses 1 or 2, where the at least one spacer defines a circular, elliptical, square, or rectangular cross-section.

Clause 4: The fibrous substrate of any of clauses 1 to 3, where the at least one roll longitudinally extends along a roll axis, and where the at least one spacer includes an elongated spacer body extending in a direction parallel to the roll axis.

Clause 5: The fibrous substrate of clause 4, where the elongated spacer body extends along an entire length of the at least one roll.

Clause 6: The fibrous substrate of any of clauses 1 to 5, where the at least one spacer includes at least one of carbon or a ceramic.

Clause 7: The fibrous substrate of any of clauses 1 to 6, where the fibrous substrate includes at least one of carbon, zirconia, or silica.

Clause 8: The fibrous substrate of any of clauses 1 to 7, where the at least one roll includes a fibrous mat.

Clause 9: The fibrous substrate of any of clauses 1 to 8, where the at least one roll longitudinally extends along a roll axis, where the at least one roll defines a plurality of grooves, and where each groove of the plurality of grooves extends along a respective direction transverse to the roll axis.

Clause 10: The fibrous substrate of any of clauses 1 to 9, where the respective direction is normal to the roll axis.

Clause 11: The fibrous substrate of any of clauses 9 or 10, where the at least one roll defines an outermost roll surface, and where at least one groove of the plurality of grooves extends to the outermost roll surface.

Clause 12: The fibrous substrate of any of clauses 9 or 10, where the at least one roll defines an outermost roll surface, and where at least one groove of the plurality of grooves does not extend to the outermost roll surface.

Clause 13: The fibrous substrate of clause 9, where at least some grooves of the plurality of grooves are arranged clockwise about the roll axis.

Clause 14: A system for generating hydrogen gas, the system including: a pyrolysis reactor configured to generate the hydrogen gas from a hydrocarbon through pyrolysis; and a fibrous substrate including: at least one roll defining a plurality of rolled deposition surfaces configured to receive carbon generated from the pyrolysis of the hydrocarbon, and at least one spacer between and spacing at least one pair of opposed deposition surfaces of the plurality of rolled deposition surfaces.

Clause 15: The system of clause 14, where the pyrolysis reactor extends along a longitudinal reactor axis, and where the at least one roll longitudinally extends in a direction parallel to the longitudinal reactor axis.

Clause 16: The system of any of clauses 14 or 15, where the at least one roll includes a spiral roll or a plurality of concentric rolls.

Clause 17: The system of any of clauses 14 to 16, where the at least one roll longitudinally extends along a roll axis, and where the at least one roll defines a plurality of grooves, each groove of the plurality of grooves extending along a respective direction transverse to the roll axis.

Clause 18: A method for forming a fibrous substrate for depositing carbon generated from pyrolysis of a hydrocarbon, the method including: positioning at least one spacer on a surface of a fibrous mat; and rolling the fibrous mat into at least one roll defining a plurality of rolled deposition surfaces configured to receive carbon generated from the pyrolysis, where the rolling causes the at least one spacer to be positioned between and spacing at least one pair of opposed deposition surfaces of the plurality of rolled deposition surfaces.

Clause 19: The method of clause 18, where the least one roll includes a spiral roll or a plurality of concentric rolls.

Clause 20: The method of any of clauses 18 or 19, where the at least one roll longitudinally extends along a roll axis, where the at least one roll defines a plurality of grooves, and wherein each groove of the plurality of grooves extends along a respective direction transverse to the roll axis.

Various examples have been described. These and other examples are within the scope of the following claims.

What is claimed is:

1. A fibrous substrate for depositing carbon generated from pyrolysis of a hydrocarbon, the fibrous substrate comprising:
at least one roll defining a plurality of rolled deposition surfaces configured to receive carbon generated from the pyrolysis; and
at least one spacer between and spacing at least one pair of opposed deposition surfaces of the plurality of rolled deposition surfaces.

2. The fibrous substrate of claim 1, wherein the at least one roll comprises at least one spiral roll or a plurality of concentric rolls.

3. The fibrous substrate of claim 1, wherein the at least one spacer defines a circular, elliptical, square, or rectangular cross-section.

4. The fibrous substrate of claim 1, wherein the at least one roll longitudinally extends along a roll axis, and wherein the at least one spacer comprises an elongated spacer body extending in a direction parallel to the roll axis.

5. The fibrous substrate of claim 4, wherein the elongated spacer body extends along an entire length of the at least one roll.

6. The fibrous substrate of claim 1, wherein the at least one spacer comprises at least one of carbon or a ceramic.

7. The fibrous substrate of claim 1, wherein the fibrous substrate comprises at least one of carbon, zirconia, or silica.

8. The fibrous substrate of claim 1, wherein the at least one roll comprises a fibrous mat.

9. The fibrous substrate of claim 1, wherein the respective direction is normal to the roll axis.

10. The fibrous substrate of claim 1, wherein the at least one roll longitudinally extends along a roll axis, wherein the at least one roll defines a plurality of grooves, and wherein each groove of the plurality of grooves extends along a respective direction transverse to the roll axis.

11. The fibrous substrate of claim 10, wherein the at least one roll defines an outermost roll surface, and wherein at least one groove of the plurality of grooves extends to the outermost roll surface.

12. The fibrous substrate of claim 10, wherein the at least one roll defines an outermost roll surface, and wherein at least one groove of the plurality of grooves does not extend to the outermost roll surface.

13. The fibrous substrate of claim 10, wherein at least some grooves of the plurality of grooves are arranged clockwise about the roll axis.

14. A system for generating hydrogen gas, the system comprising:
a pyrolysis reactor configured to generate the hydrogen gas from a hydrocarbon through pyrolysis; and
a fibrous substrate comprising:
at least one roll defining a plurality of rolled deposition surfaces configured to receive carbon generated from the pyrolysis of the hydrocarbon, and
at least one spacer between and spacing at least one pair of opposed deposition surfaces of the plurality of rolled deposition surfaces.

15. The system of claim 14, wherein the pyrolysis reactor extends along a longitudinal reactor axis, and wherein the at least one roll longitudinally extends in a direction parallel to the longitudinal reactor axis.

16. The system of claim 14, wherein the at least one roll comprises a spiral roll or a plurality of concentric rolls.

17. The system of claim 14, wherein the at least one roll longitudinally extends along a roll axis, and wherein the at least one roll defines a plurality of grooves, each groove of the plurality of grooves extending along a respective direction transverse to the roll axis.

18. A method for forming a fibrous substrate for depositing carbon generated from pyrolysis of a hydrocarbon, the method comprising:
positioning at least one spacer on a surface of a fibrous mat; and
rolling the fibrous mat into at least one roll defining a plurality of rolled deposition surfaces configured to receive carbon generated from the pyrolysis,
wherein the rolling causes the at least one spacer to be positioned between and spacing at least one pair of opposed deposition surfaces of the plurality of rolled deposition surfaces.

19. The method of claim 18, wherein the least one roll comprises a spiral roll or a plurality of concentric rolls.

20. The method of claim 18, wherein the at least one roll longitudinally extends along a roll axis, wherein the at least one roll defines a plurality of grooves, and wherein each groove of the plurality of grooves extends along a respective direction transverse to the roll axis.
